(19) United States
(12) Patent Application Publication
(10) Pub. No.: US 2008/0295713 A1
(43) Pub. Date: Dec. 4, 2008

(54) NOTCHING UNIT, FOLDER AND PRINTING PRESS

(75) Inventors: Naohiro Namiki, Hiroshima-Ken (JP); Kazutoshi Noumi, Hiroshima-Ken (JP); Mikio Motooka, Hiroshima-Ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 12/038,640

(22) Filed: Feb. 27, 2008

(30) Foreign Application Priority Data
Jun. 1, 2007 (JP) 2007-147377

(51) Int. Cl. B41F 13/56; B41F 5/16

(52) U.S. Cl. 101/174; 83/471.3; 493/325; 101/226

(57) ABSTRACT

A notching unit includes a notching blade and a notching blade holder. The notching blade holder is moved between a notch forming position where the notching blade forms intermittent notches in a folded signature and a groove waiting position where the notching blade does not form the intermittent notches in the folded signature.

### BACKGROUND OF THE INVENTION

1. Field of the Invention

The present invention relates to a notching unit, a folder, and a printing press.

2. Description of the Related Art

A generally-available web offset press includes a feeder, an in-feeder, a printer, a dryer, a cooler, a web passing device, a folder, and a discharger. The feeder includes a reel stand mounted with two reels (web rolls). A running web pulled out from one of the reels is connected to a web on the other reel to realize continuous supplying of the web. The in-feeder supplies the web pulled out from the reel on the feeder to the printer at a predetermined speed. The printer includes four sets of printing units, each corresponding to each of four colors of black, cyan, magenta, and yellow, arranged in line along the running direction of the web. The dryer dries ink on the web after the printer has performed printing thereto, and the cooler cools the web that accumulates therein excess heat after being dried by the dryer, to an appropriate temperature. The web passing device carries the dried and cooled web. The folder cuts the web folded in the vertical direction and folds the web into a predetermined size to form a folded signature. The discharger discharges the folded signature out from the printing press.

Therefore, a roll-shaped web is pulled out from the reel by the feeder, and supplied to the printer by way of the in-feeder at a predetermined speed. Each of the printing units in the printer performs printing in a plurality of colors, and the ink on the web after the printing is dried in the dryer, and cooled in the cooler. Then, the web is delivered to the folder by the web passing device to be formed into a folded signature in the folder, and discharged by the discharger.

In such a web offset press, in the folding unit, the folder includes a notching unit that forms intermittent notches in a back of the signature upon making a folded signature to be bound with notch binding. The notching unit includes a rotatable notching blade with a number of blade tips on the periphery that is arranged on the back side of the folded signature, and a notching blade holder that is arranged opposing the notching blade and includes an accepting groove on the periphery thereof. The tips of the notching blade are engaged with the accepting groove. Therefore, when the folded signature folded in the vertical direction by the folder is carried between the notching blade and the notching blade holder that rotate in opposite directions, intermittent notches are formed in the back of the folded signature.

Such a notching unit is disclosed in Japanese Patent Application Laid-Open No. 2004-238174, which includes a notching blade having cutting blades arranged intermittently on the periphery thereof and a cutting blade holder accepting the notching blade, arranged at a position downstream of folding cylinders and upstream of a chopper folding unit in the folder, and can form the notches for notch biding in the folded signature.

Upon binding, the folded signatures with intermittent notches formed in the back thereof by the conventional notching unit, are glued in the intermittent notches. The papers of the folded signature, each of which overlaps each other, are glued together integrally by the glue spreading inside from these notches to be adhered together. At the same time, when the signatures are folded along the notches formed in the running direction of the signatures and laid over one another, the notches in the signature are aligned. Therefore, the glue runs in a continuous manner, to glue a plurality of signatures that are laid over one another together integrally.

However, if a signature is made from a few sheets of thin papers, the notching unit does not form the intermittent notches in the signature. Alternatively, the signature is glued and folded to form a folded signature, and notches are formed in the folded signature along the running direction thereof at a binding process, and the signatures that are folded and laid over one another along these cuts are adhered together integrally by the glue spreading inside from the notches provided thereto.

Therefore, it is preferable to provide a gluing unit upstream of the notching unit in a folder of a web offset press. However, in such an arrangement, when the glued signature is carried between the notching blade and the notching blade holder in the notching unit, the glue thereon adheres to the notching blade or the accepting groove provided to the notching blade holder. Therefore, when the signature not necessary to be glued passes between the notching blade and the notching blade holder to form notches, the notching unit cannot form proper notches due to the glue attached to the notching blade or the accepting groove of the notching blade holder. Therefore, it has been necessary to clean the notching unit in advance to remove the attached glue, or to remove the notching blade and the notching blade holder upon conveying glued signatures. However, it is cumbersome to clean the notching unit during the printing process, and to position the notching blade and the notching blade holder after removal. Therefore, workability is deteriorated, reducing the efficiency of printing process.

### SUMMARY OF THE INVENTION

It is an object of the present invention to at least partially solve the problems in the conventional technology.

According to an aspect of the present invention, there is provided a notching unit including a notching blade that forms intermittent notches in a back portion of a folded signature, that is supported rotatably on a first supporting shaft, and that includes intermittent blades on a periphery thereof; a notching blade holder that is supported rotatably on a second supporting shaft that is parallel to the first supporting shaft and includes an accepting groove on a periphery thereof that opposes the notching blade; and a holder supporting mechanism that supports the notching blade holder movably, with respect to an axial direction of the second supporting shaft, between a notch forming position where the accepting groove opposes the notching blade so that the notching blade forms the intermittent notches in the folded signature and a groove waiting position where the accepting groove is apart from the notching blade so that the notching blade does not form the intermittent notches in the folded signature.

According to another aspect of the present invention, there is provided a folder including a gluer; a notching unit; a folding cylinder; and a cutting cylinder, wherein the gluer, the notching unit, the folding cylinder, and the cutting cylinder are arranged along a sheet-conveying direction, the notching unit includes a notching blade that forms intermittent notches in a back portion of a folded signature, that is supported rotatably on a first supporting shaft, and that includes intermittent blades on a periphery thereof, a notching blade holder that is supported rotatably on a second supporting shaft that is parallel to the first supporting shaft and includes an accepting groove on a periphery thereof that opposes the notching blade, and a holder supporting mechanism that supports the notching blade holder movably, with respect to an axial direction of the second supporting shaft, between a notch forming position where the accepting groove opposes the notching blade so that the notching blade forms the intermittent notches in the folded signature and a groove waiting position where the accepting groove is apart from the notching blade so that the notching blade does not form the intermittent notches in the folded signature.

According to still another aspect of the present invention, there is provided a printing press including a feeder that supplies a web; a printer that performs printing to the web supplied from the feeder; a dryer that dries ink on the web after printing is performed by the printer; a folder that includes a notching unit and cuts the web whose ink is dried by the dryer to form a predetermined folded signature; and a discharger that discharges the predetermined folded signature, wherein the notching unit includes a notching blade that forms intermittent notches in a back portion of the predetermined folded signature, that is supported rotatably on the first supporting shaft, and that includes intermittent blades on a periphery thereof, a notching blade holder that is supported rotatably on a second supporting shaft that is parallel to the first supporting shaft and includes an accepting groove on a periphery thereof that opposes the notching blade, and a holder supporting mechanism that supports the notching blade holder movably, with respect to an axial direction of the second supporting shaft, between a notch forming position where the accepting groove opposes the notching blade so that the notching blade forms the intermittent notches in the folded signature and a groove waiting position where the accepting groove is apart from the notching blade so that the notching blade does not form the intermittent notches in the folded signature.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a notching unit according an embodiment of the present invention;

FIG. 2 is a plan view of a notching blade and a notching blade holder provided in the notching unit according to the embodiment;

FIG. 3 is a cross sectional view taken along line III and III shown in FIG. 2;

FIG. 4 is a plan view of the notching blade and the notching blade holder moved to waiting positions in the notching unit according to the embodiment;

FIG. 5 is a schematic diagram of a web offset press including the notching unit according to the embodiment; and

FIG. 6 is a schematic diagram of a folder including the notching unit according to the embodiment.

### DETAILED DESCRIPTION OF THE PREFERRED EMBODIMENTS

Exemplary embodiment of a notching unit, a folder, and a print press of the present invention are explained below in detail with reference to the accompanying drawings. It should be understood that the embodiments are not intended to limit the scope of the present invention in any way.

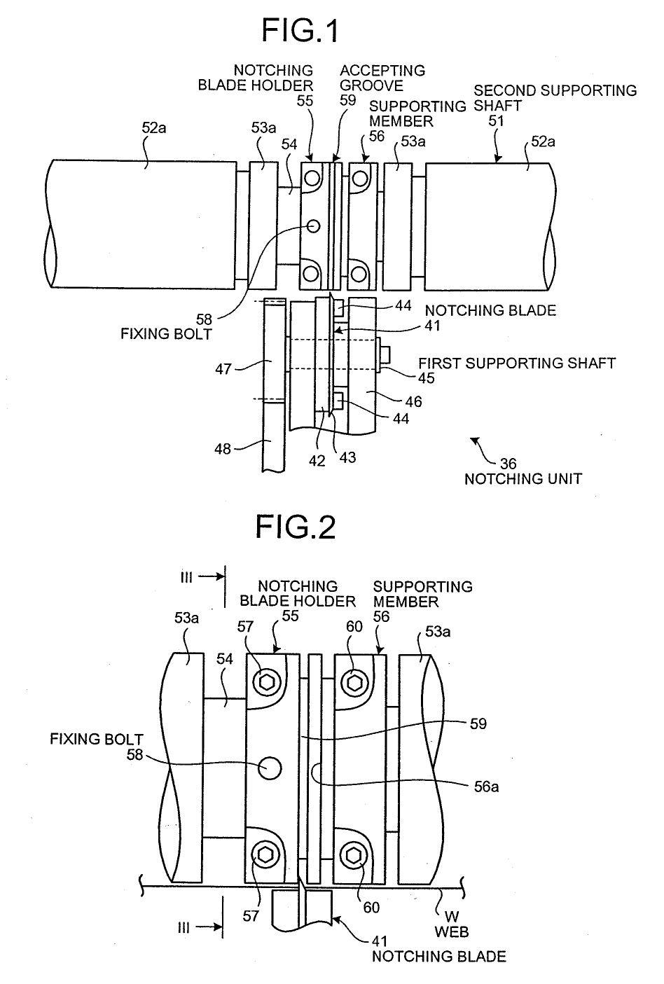

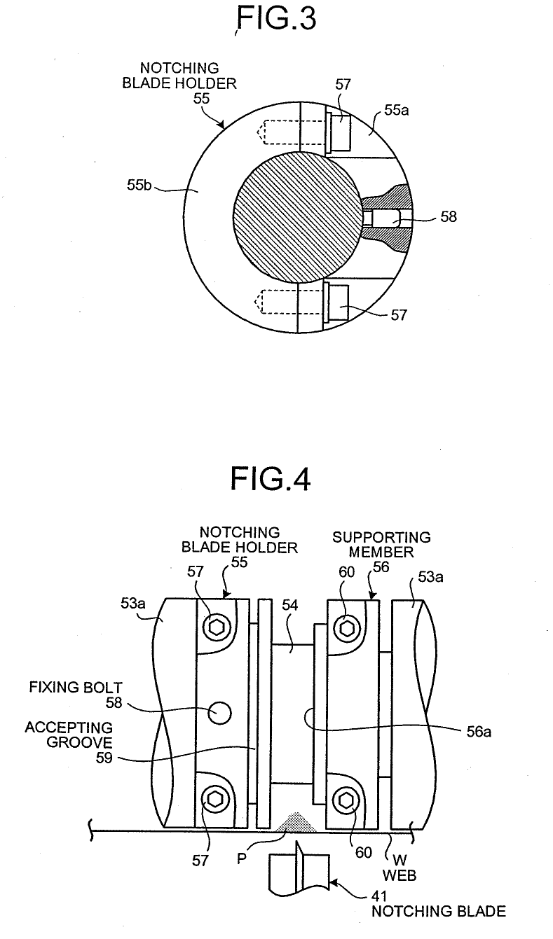

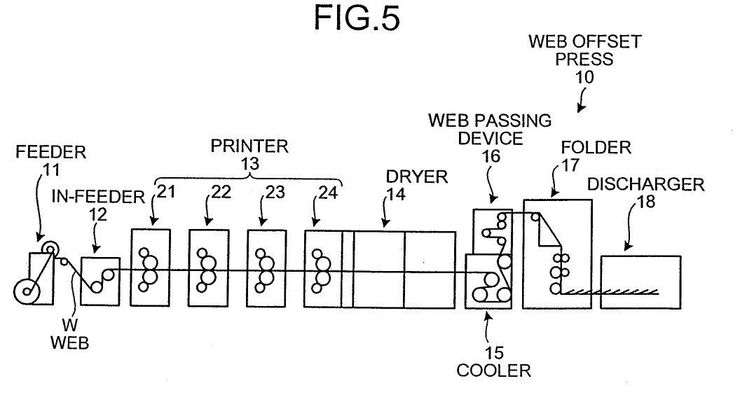

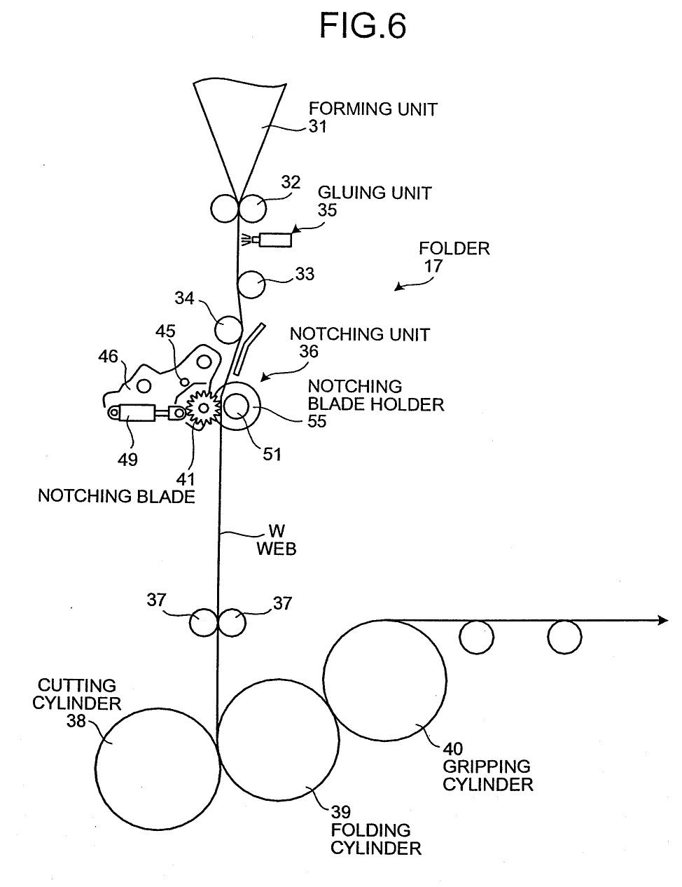

FIG. 1 is a schematic diagram of a notching unit 36 according to an embodiment of the present invention. FIG. 2 is a plan view of a notching blade 41 and a notching blade holder 55 in the notching unit 36. FIG. 3 is a cross section taken along line III and III shown in FIG. 2. FIG. 4 is a plan view of the notching blade 41 and the notching blade holder 55 moved to waiting positions in the notching unit 36. FIG. 5 is a schematic diagram of a web offset press 10 including the notching unit 36. FIG. 6 is a schematic diagram of a folder 17 including the notching unit 36 according to the embodiment.

In the embodiment, a printing press is the web offset press 10 that includes a feeder 11, an in-feeder 12, a printer 13, a dryer 14, a cooler 15, a web passing device 16, the folder 17, and a discharger 18 as shown in FIG. 5. The feeder 11 includes a reel stand mounted with two reels (web rolls). A running web pulled out from one of the reels is connected to a web on the other reel to realize continuous supplying of the web. The in-feeder 12 supplies the web from the feeder 11 to the printer 13. The printer 13 includes four sets of printing units 21, 22, 23, and 24, each corresponding to each of four colors, cyan, magenta, yellow, and black, arranged in line along the running direction of the web. The dryer 14 dries ink on the web after the printer 13 has performed printing thereto, and the cooler 15 cools the web that accumulates therein excess heat after being dried by the dryer 14 to an appropriate temperature. The web passing device 16 carries the dried and cooled web. The folder 17 cuts the web folded in the vertical direction and folds the web into a predetermined size to form a folded signature. The discharger 18 discharges the folded signature out from the web offset press 10.

Therefore, a roll-shaped web W is pulled out from the reel by the feeder 11, and the web W is supplied to the printer 13 by way of the in-feeder 12. Each of the printing units 21, 22, 23, and 24 in the printer 13 performs printing in a plurality of colors, and the ink on the web W after the printing is dried in the dryer 14, and cooled in the cooler 15. Then, the web W is delivered to the folder 17 via the web passing device 16, formed into a folded signature by the folder 17, and discharged by the discharger 18.

In the uppermost area of the folder 17 in the web offset press 10 according to the embodiment, a forming unit (triangular plate) 31 is provided to fold the web W in the vertical direction. A pair of lead-in rollers 32, and guide rollers 33 and 34 are arranged below the forming unit 31. A gluing unit 35 is arranged between the lead-in rollers 32 and the guide roller 33, and the notching unit 36 is arranged on the downstream of the guide rollers 33 and 34. The gluing unit 35 sprays the glue against the back portion of the web W, which is a folded signature folded vertically by the forming unit 31, to attach the glue thereto. The notching unit 36 forms intermittent notches on the back portion of the web W. A pair of nipping rollers 37 is provided coaxially with the notching unit 36.

Below the notching unit 36, the nipping rollers 37, a cutting cylinder 38, a folding cylinder 39, and a gripping cylinder 40 are provided. The cutting cylinder 38, the folding cylinder 39, and the gripping cylinder 40 are set in contact one after another. The cutting cylinder 38 includes a cutting blade (not shown) on the periphery thereof, so that the web W that is folded in the vertical direction can be cut to a predetermined length. The folding cylinder 39 includes a needle unit (not shown) on the periphery thereof. The needle unit operates along with rotations of the folding cylinder 39, and causes a needle to outwardly penetrate through the web W at a predetermined position to hold a fore-end of the cut web W with respect to the running direction thereof, and removes the needle at a predetermined position to release the fore-end of the web W, which has been held thereby. The folding cylinder 39 includes an inserting blade (not shown) on the periphery thereof. The inserting blade is outwardly pushed out to fold the cut web W in a horizontal direction at the center thereof with respect to the running direction. The gripping cylinder 40 includes a gripping unit (not shown) on the periphery thereof. The gripping unit operates along with rotations of the gripping cylinder 40, and can fold the web W in a horizontal direction by griping the center of the web W that is pushed out by the inserting blade from the external surface of the folding cylinder 39.

Therefore, the web W, folded in the vertical direction in the forming unit 31, is either glued on the back portion by the gluing unit 35 while running with a guide of the lead-in rollers 32, or provided with intermittent notches on the back portion by the notching unit 36 while running with a guide of the guide rollers 33 and 34. Subsequently, the web W is held by the nipping rollers 37 to be sent to the cutting cylinder 38, the folding cylinder 39, and the gripping cylinder 40.

When the web W folded in the vertical direction is carried between the cutting cylinder 38 and the folding cylinder 39, the needle unit operates at a predetermined position to causes the needle to outwardly penetrate through the web W to hold the fore-end thereof. At this time, the folding cylinder 39 continues to rotate to carry the web W that is held on the periphery of the folding cylinder 39. Then, at a predetermined position, the web W is cut in a horizontal direction by the cutting blade. Subsequently, the needle unit operates to remove the needle, releasing the web W held at the fore-end thereof. At the same time, the inserting blade is outwardly pushed out from the periphery of the folding cylinder 39 to remove the web W from the periphery of the folding cylinder 39. The web W that is pushed out from the periphery of the folding cylinder 39 is gripped by the gripping unit on the gripping cylinder 40, and formed into a folded signature.

The notching unit provided in the folder 17 in the web offset press 10 according to the embodiment is explained in detail. As shown in FIGS. 1 and 6, the notching blade 41 in the notching unit 36 includes a disk-shaped rotating body 42, and a rotating blade 43 that includes a plurality of intermittent blade-tips on the periphery thereof. The rotating blade 43 is fixed onto the rotating body 42 with bolts 44. The notching blade 41 is integrally fixed onto a first supporting shaft 45, and supported rotatably in a state of being sandwiched between a pair of frames 46. A driving gear 47 is fixed onto one end of the first supporting shaft 45. The driving gear 47 is connected to an output gear of a driving motor (not shown) via a communicating gear 48 to be driven by the driving motor. The notching blade 41 can be moved in the radial direction of the first supporting shaft 45 by an air cylinder 49. In this manner, the notching blade 41 can be moved between a processing position and a waiting position. The processing position is a position where the notching blade 41 becomes inserted to an accepting groove 59 of the notching blade holder 55 as shown in FIG. 2, so that notches are formed in the conveyed web W. The waiting position is a position where the notching blade 41 is moved away from the accepting groove 59 of the notching blade holder 55 as shown in FIG. 4, so that the notching blade 41 is apart from the web W by a predetermined distance.

As shown in FIGS. 1 to 3 and FIG. 6, a second supporting shaft 51 is supported rotatably on a pair of frames (not shown) to be parallel to the first supporting shaft 45. The second supporting shaft 51 can be rotated by a driving motor (not shown). The second supporting shaft 51 includes a small-diameter portion 54 between a pair of large-diameter portions 52a and 52b via stepping portions 53a and 53b. The notching blade holder 55 and a supporting member 56 are attached onto the small-diameter portion 54.

The notching blade holder 55 includes two semicircular ring members 55a and 55b. Each of the ring members 55a and 55b is closely attached to each other to surround the periphery of the small-diameter portion 54 provided on the second supporting shaft 51, and is connected to each other by two connecting bolts 57. The ring members 55a and 55b are also fixed onto a predetermined position of the small-diameter portion 54 by a fixing bolt (fixing member) 58 that allows attachment and removal of the notching blade holder 55. The notching blade holder 55 includes the accepting groove 59 that opposes the notching blade 41 on the periphery thereof.

The supporting member 56 includes two semicircular ring members. Each of the ring members is closely attached to each other to surround the periphery of the small-diameter portion 54 provided on the second supporting shaft 51. The ring members are connected to each other by two connecting bolts 60 that allow attachment and removal of the supporting member 56 from a predetermined position of the small-diameter portion 54.

The notching blade holder 55 is supported movably in an axial direction of the second supporting shaft 51, so that the notching blade holder 55 can be moved between a blade accepting position (notch forming position) where the notching blade 41 is accepted by the accepting groove 59 and a waiting position where the accepting groove 59 is apart from the notching blade 41. An end surface 56a of the supporting member 56 functions as a stopper to position the notching blade holder 55 to the blade accepting position. In other words, the notching blade holder 55 that is supported movably on the small-diameter portion 54 is located adjacent to the supporting member 56 in a state where the supporting member 56 is fixed onto the small-diameter portion 54. At this time, as shown in detail in FIG. 2, the notching blade holder 55 can be positioned by fixing the notching blade holder 55 to a position where the notching blade holder 55 is in contact with the end surface (stopper) 56a with the fixing bolt 58. Furthermore, as shown in detail in FIG. 4, the notching blade holder 55 can be positioned to the waiting position by fixing the notching blade holder 55 to a position where the notching blade holder 55 is in contact with the stepping portion 53a with the fixing bolt 58.

Therefore, when the gluing unit 35 is not used, the notching blade holder 55 is moved to be in contact with the end surface (stopper) 56a, and fixed to that position by the fixing bolt 58 as shown in FIG. 2, thereby positioning the notching blade holder 55 to the blade accepting position, and the notching blade 41 is positioned to the processing position where the tips of the notching blade 41 are accepted into the accepting groove 59 by moving the notching blade 41 by the air cylinder 49.

At this position, as shown in FIG. 6, the first supporting shaft 45 is rotated clockwise in FIG. 6, and the second supporting shaft 51 is rotated counterclockwise in FIG. 6 by a driving motor (not shown). By way of these rotations, when the web W that is folded in the vertical direction by the forming unit 31 passes between the notching blade 41 and the notching blade holder 55 in the notching unit 36, intermittent notches are formed in the back portion of the web W in a state where the web W is supported on the periphery of the notching blade holder 55. Subsequently, the web W is supported by the nipping rollers 37, and conveyed to the cutting cylinder 38, the folding cylinder 39, and the gripping cylinder 40.

When the gluing unit 35 is not used, the notching blade 41 is positioned to the waiting position where the notching blade 41 is apart from the blade accepting position of the accepting groove 59 by moving the notching blade 41 away from the position shown in FIG. 2 with the air cylinder 49. At the same time, the fixing bolt 58 are loosened to allow the notching blade holder 55 to be moved in an axial direction of the second supporting shaft 51, and the notching blade holder 55 is moved to a position to be in contact with an end surface of the stepping portion 53a. By fixing the notching blade holder 55 to this position with the fixing bolt 58, the notching blade holder 55 is positioned to the waiting position. In this arrangement, the notching blade 41 is apart from the web W passing through the notching unit 36, and the notching blade holder 55 is shifted in the width direction of the web W, from a glued position P of the web W passing through the notching unit 36.

Therefore, as shown in FIG. 6, the web W that is folded in the vertical direction by the forming unit 31 is glued on the back portion thereof by the gluing unit 35. Upon passing between the notching blade 41 and the notching blade holder 55 in the notching unit 36, notches are not formed in the glued web W because the notching blade 41 is apart from the web W. Furthermore, because the accepting groove 59 of the notching blade holder 55 is shifted from the glued position P of the web W in the width direction of the web W, the accepting groove 59 does not become dirty by the glue on the web W. Subsequently, the web W is supported by the nipping rollers 37, and conveyed to the cutting cylinder 38, the folding cylinder 39, and the gripping cylinder 40.

As described above, in the notching unit 36 according to the embodiment, the notching blade 41 that includes intermittent blades on a periphery thereof is supported rotatably on the first supporting shaft 45, and the notching blade holder 55 that includes the accepting groove 59 on the periphery thereof that opposes the notching blade 41 is supported rotatably on the second supporting shaft 51 that is parallel to the first supporting shaft 45. The notching blade holder 55 is supported movably between the blade accepting position where the accepting groove 59 opposes the notching blade 41 and the waiting position where the accepting groove 59 is apart from the notching blade 41.

Therefore, when the notching unit 36 is used, the notching blade holder 55 is moved to the blade accepting position where the accepting groove 59 opposes the notching blade 41. In this arrangement, intermittent notches are formed in the back portion of the web W by the notching blade 41 upon passing between the notching blade 41 and the notching blade holder 55. When the notching unit 36 is not used, the notching blade holder 55 is moved to the waiting position, so that the accepting groove 59 is apart from the notching blade 41. Therefore, for example, the accepting groove 59 on the notching blade holder 55 does not become dirty by the glue attached to the web W, omitting necessity of cleaning, thus allowing improvement of the workability.

Furthermore, in the notching unit 36 according to the embodiment, because the notching blade 41 is movably supported with respect to the radial direction of the first supporting shaft 45 between the processing position where the notching blade 41 is accepted into the accepting groove 59 of the notching blade holder 55 and the waiting position where the notching blade 41 is apart from the accepting groove 59. Therefore, when the notching unit 36 is used, the notching blade holder 55 is moved to the blade accepting position and the notching blade 41 is moved to the processing position, so that the notching blade 41 is accepted by the accepting groove 59. Thus, the intermittent notches are formed in the back portion of the web W by the notching blade 41 upon passing between the notching blade 41 and the notching blade holder 55. When the notching unit 36 is not used, the notching blade 41 and the notching blade holder 55 are moved to the waiting positions thereof, so that the notching blade 41 is apart from the accepting groove 59 and the accepting groove 59 is shifted in the width direction of the web W. Therefore, for example, the accepting groove does not become dirty by the glue attached to the signature, omitting necessity of cleaning, thus allowing improvement of the workability.

Furthermore, according to the embodiment, the second supporting shaft 51 includes the supporting member 56 as a stopper for positioning the notching blade holder 55 to the blade accepting position. When the notching blade holder 55 is moved from the waiting position to the blade accepting position, the notching blade holder 55 can be positioned easily by fixing the notching blade holder 55 to a position where the notching blade holder 55 is in contact with the end surface 56a. At this time, the supporting member 56 is attached to the second supporting shaft 51 in a removable manner, and the notching blade holder 55 is supported adjacent to the supporting member 56 in a movable manner. By fixing the notching blade holder 55 to a position to be in contact with the end surface 56a, with the supporting member 56 attached to the second supporting shaft 51, the notching blade holder 55 is positioned to the blade accepting position. Because the supporting member 56, used for positioning the notching blade holder 55, is removable from the second supporting shaft 51, the blade accepting position of the notching blade holder 55 can be easily changed simply by replacing the supporting member 56. In other words, depending on the type of the folded signature (web W), the notches may be formed to positions shifted either to the right or to the left from the center in the width direction, instead of along the center of the signature in the width direction. In such a situation, the fixing position of the notching blade holder 55 can be changed easily by replacing the supporting member 56 to another one with a different width. Therefore, general versatility can be achieved, depending on various types of folding process.

Furthermore, in the notching unit 36 according to the embodiment, the notching blade holder 55 includes the two semicircular ring members 55a and 55b, which are connected to each other to surround the periphery of the second supporting shaft 51. The ring members 55a and 55b are connected to each other with the connecting bolts 57, and fixed to the blade accepting position or the waiting position of the second supporting shaft 51 with the fixing bolt 58. In this manner, the structure of the notching blade holder 55 can be simplified, and attachabilty of the notching blade holder 55 to the second supporting shaft 51 can be improved.

Furthermore, in the folder and the print press according to the embodiment, the notching blade 41 in the notching unit 36 can be moved to the processing position and the waiting position, and the notching blade holder 55 can be moved to the blade accepting position and the waiting position. Therefore, when the notching unit 36 is not used, the position of the accepting groove 59 can be shifted in the width direction from the glued position P of the web W by moving the notching blade 41 and the notching blade holder 55 to the waiting positions. Therefore, the accepting groove 59 in the notching blade holder 55 does not become dirty by the glue attached to the web W, omitting necessity of cleaning, thus allowing improvement of the workability of folding process or printing process.

In the above embodiment, the gluing unit 35 and the notching unit 36 are arranged at positions downstream of the forming unit 31 and upstream of the cutting cylinder 38, the folding cylinder 39, and the gripping cylinder 40 with respect to the conveying direction of the web W. However, the positions are not limited to these, and the gluing unit 35 and the notching unit 36 can also be arranged at a position downstream of the cutting cylinder 38, the folding cylinder 39, and the gripping cylinder 40 with respect to the conveying direction of the web W.

According to one aspect of the present invention, the accepting groove on the notching blade holder does not become dirty, for example, by glue attached to the folded signature, omitting necessity of cleaning, thus the workability can be improved.

According to another aspect of the present invention, the notching blade does not become dirty, for example, by glue attached to the folded signature, omitting necessity of cleaning, thus the workability can be improved.

According to still another aspect of the present invention, the notching blade holder can be positioned easily.

According to still another aspect of the present invention, general versatility can be improved, achieving various types of folding processes.

According to still another aspect of the present invention, the structure of the notching blade holder can be simplified, and attachabilty of the notching blade holder to the second supporting shaft can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A notching unit comprising:
a notching blade that forms intermittent notches in a back portion of a folded signature, that is supported rotatably on a first supporting shaft, and that includes intermittent blades on a periphery thereof;
a notching blade holder that is supported rotatably on a second supporting shaft that is parallel to the first supporting shaft and includes an accepting groove on a periphery thereof that opposes the notching blade; and
a holder supporting mechanism that supports the notching blade holder movably, with respect to an axial direction of the second supporting shaft, between a notch forming position where the accepting groove opposes the notching blade so that the notching blade forms the intermittent notches in the folded signature and a groove waiting position where the accepting groove is apart from the notching blade so that the notching blade does not form the intermittent notches in the folded signature.

2. The notching unit according to claim 1, further comprising:
a blade supporting mechanism that supports the notching blade movably, with respect to a radial direction of the first supporting shaft, between a processing position where the notching blade is accepted into the accepting groove so that the notching blade forms the intermittent notches in the folded signature and a blade waiting position where the notching blade is apart from the accepting groove so that the notching blade does not form the intermittent notches in the folded signature.

3. The notching unit according to claim 1, further comprising a stopper that positions the notching blade holder to the notch forming position.

4. The notching unit according to claim 2, further comprising a stopper that positions the notching blade holder to the notch forming position.

5. The notching unit according to claim 3, further comprising a supporting member that includes the stopper and is removably attached to the second supporting shaft, wherein
the notching blade holder is movably supported in adjacent to the supporting member, and
the notching blade holder is positioned to the notch forming position by fixing the notching blade holder in contact with the stopper, with the supporting member attached to the second supporting shaft.

6. The notching unit according to claim 4, further comprising a supporting member that includes the stopper and is removably attached to the second supporting shaft, wherein
the notching blade holder is movably supported in adjacent to the supporting member, and
the notching blade holder is positioned to the notch forming position by fixing the notching blade holder in contact with the stopper, with the supporting member attached to the second supporting shaft.

7. The notching unit according to claim 1, wherein
the notching blade holder comprises a plurality of semicircular ring members,
the semicircular ring members are connected to each other to surround a periphery of the second supporting shaft, and
the notching blade holder is fixed to at least one of the notch forming position and the groove waiting position on the second supporting shaft.

8. The notching unit according to claim 2, wherein
the notching blade holder comprises a plurality of semicircular ring members,
the semicircular ring members are connected to each other to surround a periphery of the second supporting shaft, and
the notching blade holder is fixed to at least one of the notch forming position and the groove waiting position on the second supporting shaft.

9. The notching unit according to claim 3, wherein
the notching blade holder comprises a plurality of semicircular ring members,
the semicircular ring members are connected to each other to surround a periphery of the second supporting shaft, and
the notching blade holder is fixed to at least one of the notch forming position and the groove waiting position on the second supporting shaft.

10. The notching unit according to claim 4, wherein
the notching blade holder comprises a plurality of semicircular ring members,
the semicircular ring members are connected to each other to surround a periphery of the second supporting shaft, and
the notching blade holder is fixed to at least one of the notch forming position and the groove waiting position on the second supporting shaft.

11. The notching unit according to claim 5, wherein
the notching blade holder comprises a plurality of semicircular ring members,
the semicircular ring members are connected to each other to surround a periphery of the second supporting shaft, and
the notching blade holder is fixed to at least one of the notch forming position and the groove waiting position on the second supporting shaft.

12. The notching unit according to claim 6, wherein
the notching blade holder comprises a plurality of semicircular ring members,
the semicircular ring members are connected to each other to surround a periphery of the second supporting shaft, and
the notching blade holder is fixed to at least one of the notch forming position and the groove waiting position on the second supporting shaft.

13. A folder comprising:
a gluer;
a notching unit;
a folding cylinder; and
a cutting cylinder, wherein
the gluer, the notching unit, the folding cylinder, and the cutting cylinder are arranged along a sheet-conveying direction,
the notching unit includes
a notching blade that forms intermittent notches in a back portion of a folded signature, that is supported rotatably on a first supporting shaft, and that includes intermittent blades on a periphery thereof,
a notching blade holder that is supported rotatably on a second supporting shaft that is parallel to the first supporting shaft and includes an accepting groove on a periphery thereof that opposes the notching blade, and
a holder supporting mechanism that supports the notching blade holder movably, with respect to an axial direction of the second supporting shaft, between a notch forming position where the accepting groove opposes the notching blade so that the notching blade forms the intermittent notches in the folded signature and a groove waiting position where the accepting groove is apart from the notching blade so that the notching blade does not form the intermittent notches in the folded signature.

14. A printing press comprising:
a feeder that supplies a web;
a printer that performs printing to the web supplied from the feeder;
a dryer that dries ink on the web after printing is performed by the printer;
a folder that includes a notching unit and cuts the web whose ink is dried by the dryer to form a predetermined folded signature; and
a discharger that discharges the predetermined folded signature, wherein
the notching unit includes
a notching blade that forms intermittent notches in a back portion of the predetermined folded signature, that is supported rotatably on a first supporting shaft, and that includes intermittent blades on a periphery thereof,
a notching blade holder that is supported rotatably on a second supporting shaft that is parallel to the first supporting shaft and includes an accepting groove on a periphery thereof that opposes the notching blade, and
a holder supporting mechanism that supports the notching blade holder movably, with respect to an axial direction of the second supporting shaft, between a notch forming position where the accepting groove opposes the notching blade so that the notching blade forms the intermittent notches in the folded signature and a groove waiting position where the accepting groove is apart from the notching blade so that the notching blade does not form the intermittent notches in the folded signature.
